(19) United States
(12) Patent Application Publication
(10) Pub. No.: US 2010/0232453 A1
(43) Pub. Date: Sep. 16, 2010

(54) INFORMATION PROCESSING APPARATUS AND MULTIPLEXING METHOD

(75) Inventor: Jun OHASHI, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/703,695

(22) Filed: Feb. 10, 2010

(30) Foreign Application Priority Data
Mar. 10, 2009 (JP) 2009-056931

(51) Int. Cl. H04J 3/22; H04N 7/24

(52) U.S. Cl. 370/468; 375/E07.011

(57) ABSTRACT

According to one embodiment, an information processing apparatus includes an output rate adjustment module which sets an output rate adjustment stream data, an output rate adjustment start time and an output rate adjustment end time. The output rate adjustment module calculates an output data amount of the output rate adjustment stream data in the difference interval between the output rate adjustment start time and the output rate adjustment end time using coding parameter of the output rate adjustment stream data, and increases the output rate of the output rate adjustment stream data while sustaining the output rate of the multiplexed stream data and sustaining a data size in a buffer of the decoder smaller or equal to the size of the buffer.

### CROSS-REFERENCE TO RELATED APPLICATIONS

This application is based upon and claims the benefit of priority from Japanese Patent Application No. 2009-056931, filed Mar. 10, 2009, the entire contents of which are incorporated herein by reference.

### BACKGROUND

1. Field

One embodiment of the invention relates to a packet multiplexing technique suitable for, for example, a transcoder for converting digital broadcast stream data.

2. Description of the Related Art

In recent years, stream data obtained by multiplexing video information, audio information, attribute information, and other information has been transmitted and received widely through the Internet or terrestrial broadcasting. Since the wireless communication environment has been created, if a person carries a battery-powered personal computer or the like capable of receiving and reproducing the stream data, it is possible to watch, for example, digital broadcasts at an outside location or during transit.

In such a situation, various mechanisms have been proposed which are for transmitting stream data in such a manner that the occurrence of a delay is minimized on the reproduction side (e.g., refer to Jpn. Pat. Appln. KOKAI Publication No. 2005-217556).

In Jpn. Pat. Appln. KOKAI Publication No. 2005-217556 and other relevant documents, a delay due to the buffering of stream data (particularly, video data) necessary at the start of reproduction on the reproduction side has not been considered at all. Accordingly, even if various mechanisms proposed so far are applied, a delay of about several seconds is allowed to occur at start of reproduction.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a part of the configuration of an information processing apparatus according to an embodiment of the invention;

FIG. 2 is an exemplary functional block diagram of a multiplexer included in the information processing apparatus of the embodiment;

FIG. 3 is an exemplary diagram to explain a Transport System Target Decoder (T-STD) as a decoder model;

FIG. 4 is an exemplary functional block diagram of a multiplexing module in the multiplexer included in the information processing apparatus of the embodiment;

FIG. 5 is an exemplary flowchart showing a flow of a multiplexing process performed by the multiplexing module in the multiplexer included in the information processing apparatus of the embodiment;

FIG. 6 is an exemplary flowchart showing a detailed flow of a multiplexing start time adjustment process during a multiplexing process performed by the multiplexing module in the multiplexer included in the information processing apparatus of the embodiment; and

FIG. 7 is an exemplary conceptual diagram visually describing the adjustment of the multiplexing start time during a multiplexing process performed by the multiplexing module in the multiplexer included in the information processing apparatus of the embodiment.

### DETAILED DESCRIPTION

Various embodiments according to the invention will be described hereinafter with reference to the accompanying drawings. In general, according to one embodiment of the invention, an information processing apparatus includes an output rate adjustment module which sets an output rate adjustment stream data, an output rate adjustment start time and an output rate adjustment end time. The output rate adjustment module calculates an output data amount of the output rate adjustment stream data in the difference interval between the output rate adjustment start time and the output rate adjustment end time using coding parameter of the output rate adjustment stream data, and increases the output rate of the output rate adjustment stream data without changing the output rate of the multiplexed stream data and without causing a buffer of a decoder to overflow.

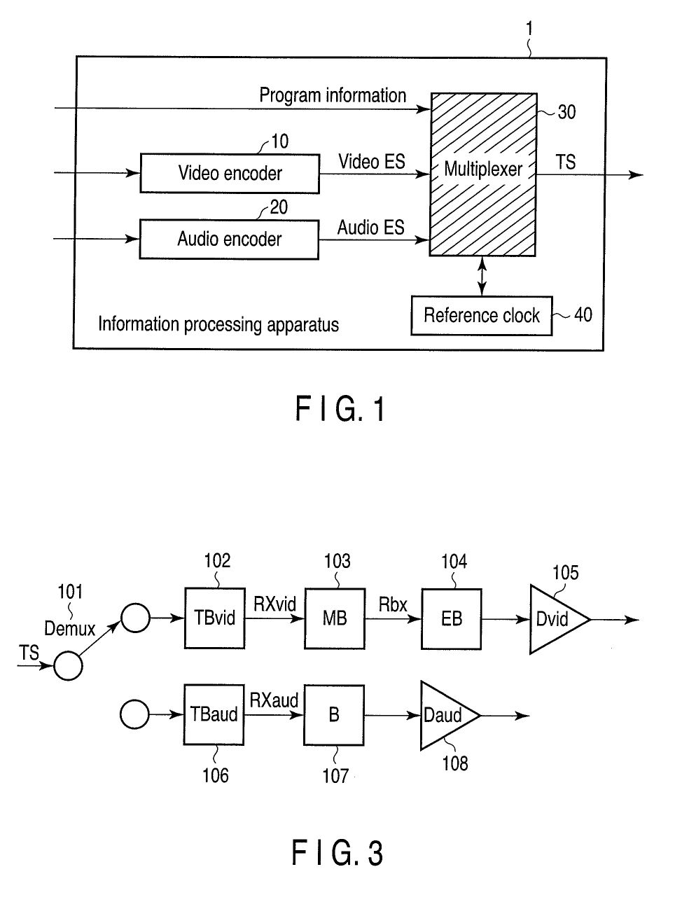

FIG. 1 is an exemplary view showing a part of the configuration of an information processing apparatus according to an embodiment of the invention. The information processing apparatus 1 includes the function of operating as a transcoder that converts, for example, a Transport Stream (TS) in terrestrial digital broadcasting. More specifically, the information processing apparatus 1 demultiplexes, by using a demultiplexer, the input TS into program information, video data, audio data and others, subjects the desired data to a specific conversion process, encodes and multiplexes the resulting data, and transmits the multiplexed data as a TS at a predetermined output rate (transport rate).

As shown in FIG. 1, the information processing apparatus 1 includes a video encoder 10, an audio encoder 20, a multiplexer 30 and a reference clock 40. Suppose the information processing apparatus 1 complies with the ISO/IEC 13818-1 MPEG-2 System standard and the ARIB TR-B14 terrestrial digital television broadcasting regulations, and outputs a TS composed of TS packets with a fixed length of 188 bytes.

The video encoder 10 inputs uncompressed video data, such as ITUBT656, and compresses the input data to generate a video Elementary Stream (video ES). The video ES generated by the video encoder 10 is output to the multiplexer 30 and accumulated in a video buffer 32 (described later) in the multiplexer 30. The audio encoder 20 inputs, for example, uncompressed Pulse Code Modulation (PCM) data and compresses the input data to generate an audio Elementary Stream (audio ES). The audio ES generated by the audio encoder 20 is output to the multiplexer 30 and accumulated in an audio buffer 33 (described later) in the multiplexer 30. At this time, each of the encoders 10 and 20 outputs a Decoding Time Stamp (DTS) and a Presentation Time Stamp (PTS), which are 90-kHz clock, to the multiplexer 30 on a picture basis and an audio frame basis, respectively.

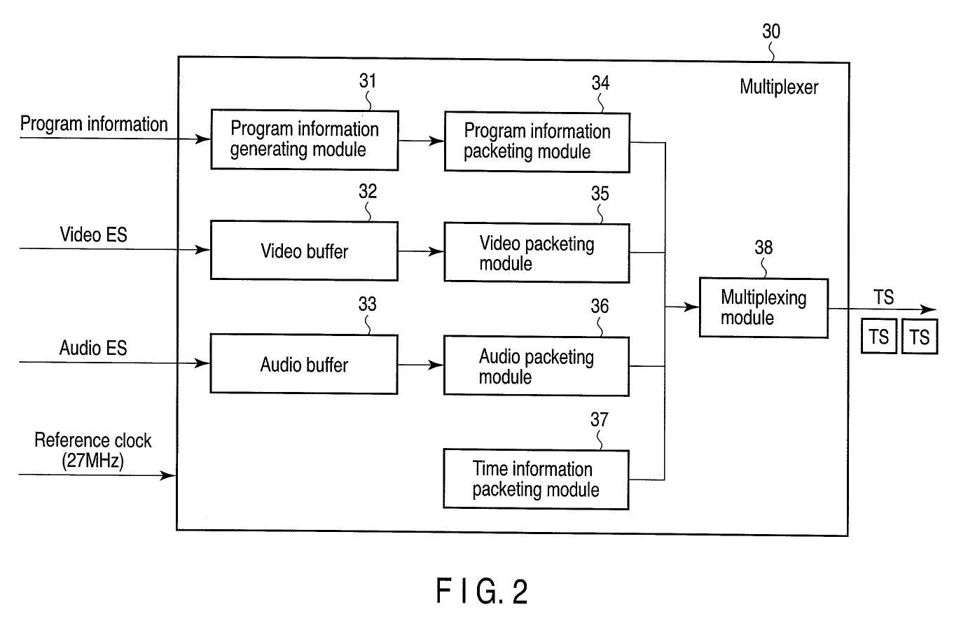

Then, the multiplexer 30 generates and transmits a TS by multiplexing a plurality of data including the video ES output from the video encoder 10 and the audio ES output from the audio encoder 20. FIG. 2 is an exemplary functional block diagram of the multiplexer 30 included in the information processing apparatus 1. Hereinafter, the operation of the multiplexer 30 will be explained with reference to FIG. 2. The reference clock 40 is a clock module that generates a 27-MHz reference clock used as a reference when the multiplexer 30 performs a multiplexing process. The reference clock is also referred to when a time information picketing module 37 (described later) in the multiplexer 30 generates a Program Clock Reference (PCR) used to synchronize with a decoder (that produces the TS output from the multiplexer 30).

The multiplexer 30 receives a coding parameter from each of the video encoder 10 and audio encoder 20, and determines a transport rate, an output rate of TS (from the multiplexer 30), based on the received coding parameter and the input program information. The transport rate is obtained by adding a TS rate (the formula for calculation of which will be described later) to which an overhead of TS,PES header has been added, and the TS rate of PSI/SI,PCR to the video/audio coding rate.

The multiplexer 30 also multiplexes program information separately received from audio and video information to include it in the TS. The input program information includes information on a program such as program name, broadcast time and date, contents of broadcasts etc., and information on a network for transmission such as channel number, modulation method, guard intervals, etc. These items of information are encoded by a program information generating module 31 into an Event Information Table (EIT) and a Network Information Table (NIT). In addition to the EIT and NIT, the program information generating module 31 generates a Program Association Table (PAT) representing a program list included in the TS, a Program Map Table (PMT) storing the PID of each of the video ES and audio ES in a program, and others. These are referred to as Program Specific Information/Service Information (PSI/SI). These PSI/SI items are packetized by a program information packetizing module 34 into TS packets with a specific period determined in ARIB TR-B14.

A video packetizing module 35 and an audio packetizing module 36 form the video ES and audio ES accumulated in the video buffer 32 and audio buffer 33 into PES packets in units of an N number (N=>1) of Access Units (AUs), and add the decode time DTS and display time PTS to header of these PES packets. An AU is a reproduction unit. In video, a picture corresponds to an AU. In audio, an audio frame corresponds to an AU. DTS is added only when the decode time differs from the display time. Specifically, DTS is added to a B picture used in H.264 or the like. Then, the video packetizing module 35 and audio packetizing module 36 turn the generated PES packet into a TS packet. When the encoding method used for the input video is based on H.264, the video packetizing module 35 also carries out the process of eliminating the HRD parameter in the video ES. This process is a process related to T-STD explained later.

Referring to the reference clock, a time information packetizing module 37 determines PCR, taking a delay in the decoder into account, and generates a TS packet where PCR has been added to the header. The TS packet added PCR is generated at specific intervals of time, for example, at intervals of 100 ms.

Various TS packets generated as described above are identified by a demultiplexer on the decoder side on the basis of the PID in the TS header.

Various TS packets generated by each of the packetizing modules 34, 35, 36, 37 are supplied to a multiplexing module 38, which suitably selects a TS packet to be output. The restrictions on the selection of TS packets to be output are: (i) the transmission period of each of PSI/SI and PCR has to be kept constant, and (ii) the output rate of each of video and audio has to be controlled in such a manner that video and audio has to conform to a buffering model determined by a Transport System Target Decoder (T-STD), a decoder model. When there is no TS packet, the multiplexing module 38 outputs a NULL packet.

Here, the T-STD will be explained with reference to FIG. 3.

In the T-STD, a plurality of buffers are provided for each of video and audio. A buffer size, a transfer rate from a buffer, and prohibited matters have been determined in the T-STD.

The TS input to Demux 101 is switched between Bvid 102 and TBaud 106 on the basis of the PID. The TS input TBvid 102 is produced into a PES packet, which is output to MB 103 at an output rate of RXvid. MB 103 removes the PES header, and EB 104 inputs them as an ES to at an output rate of Rbx. Then, when the decode time specified by each of the DTS and PTS has been reached, an AU input to EB 104 is output immediately to a decoder (Dvid) 105, which decodes the AU.

The TS input to TBaud 106 is produced into a PES packet, which is output to B 107 at an output rate of RXaud. Then, when the decode time specified by PTS has been reached, the AU input to B 107 is output immediately to a decoder (Daud) 108, which decodes the AU.

At this time, if the AU is video, a maximum input TS rate that prevents TBvid 102 and MB 103 from overflowing is set as the maximum decoder input rate. If the AU is audio, a maximum input TS rate that prevents Tbaud 106 from overflowing is set as the maximum decoder input rate. Since RXvid <=Rbs holds in the case of video, the maximum decoder input rate of video is RXvid and that of audio is RXaud. When the maximum decoder input rate is set as the upper limit of the input to the decoder, there is no need to manage the buffer capacity of each of TBvid 102, MB 103, and TBaud 106.

Furthermore, a transmission delay calculated in TS packets on the basis of the transfer rate between buffers, or the minimum value of a delay occurring from when one TS packet is input to Demux 101 until it is decoded is set as a decoder delay. In the case of video, the decoder delay is calculated by using expression (1):

188×8/RXvid+188×8/Rbx Expression (1)

In the case of audio, the decoder delay is calculated by using expression (2):

188×8/Rxaud Expression (2)

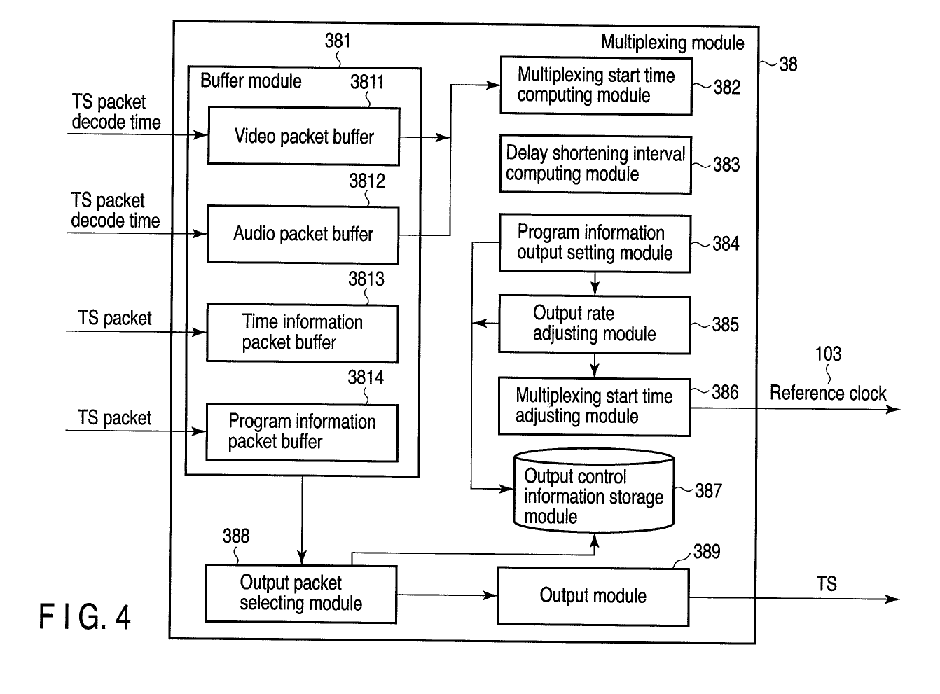

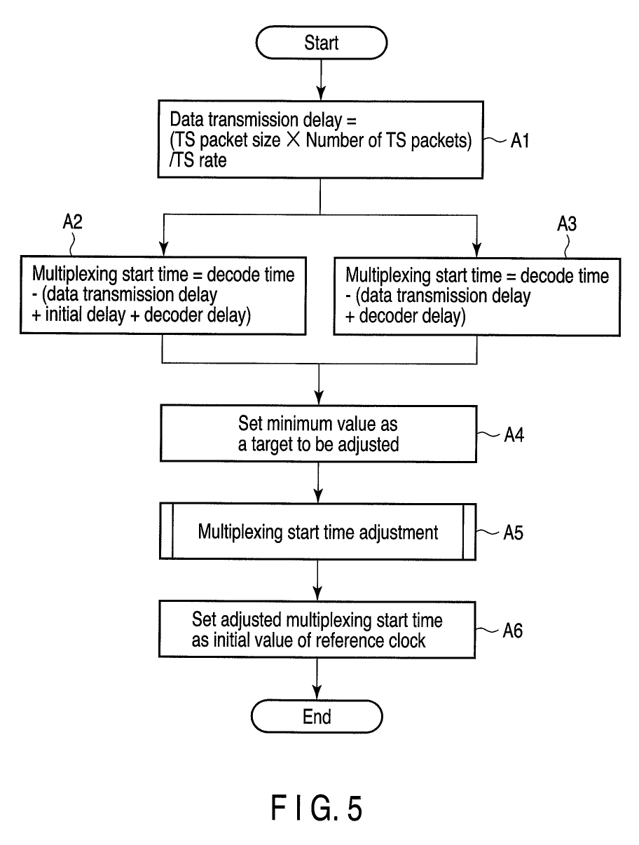

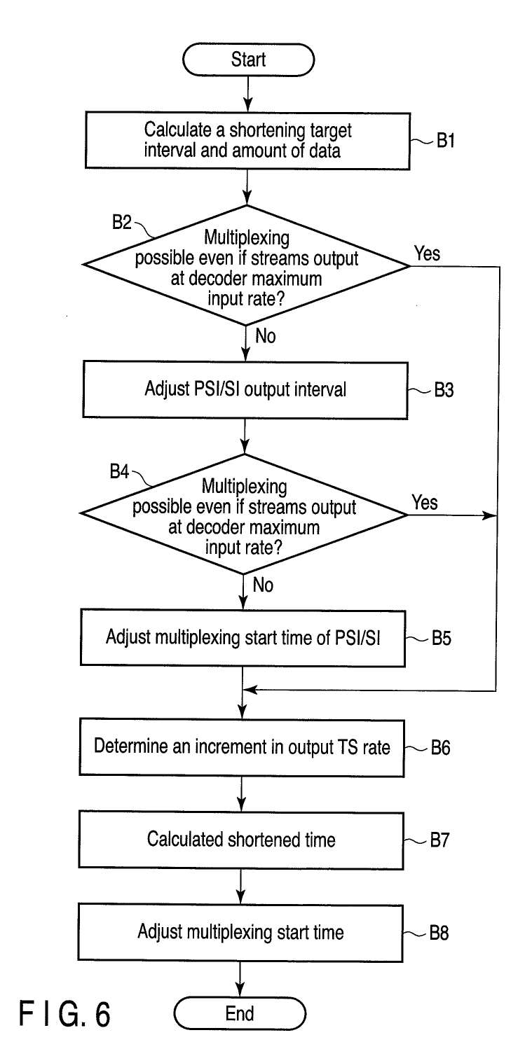

Taking what has been described above into account, the contents of the process at the start of multiplexing performed by the multiplexer 30 included in the information processing apparatus 1 will be explained with reference to FIG. 4, FIG. 5 and FIG. 6.

FIG. 4 is an exemplary functional block diagram of the multiplexing module 38 in the multiplexer 30.

When a first AU formed into a TS packet is input to a video packet buffer 3811 and an audio packet buffer 1812, a multiplexing start time calculator 382 calculates a multiplexing start time. The multiplexing start time is the time at which the first TS packet of the first AU starts to be output. That is to say, the multiplexing start time is the latest time at which if output is started at the TS rate calculated on the basis of the coding rate of each of the encoders 10 and 20, the packet can be reproduced without causing the T-STD to break down.

FIG. 5 is an exemplary flowchart showing the flow of a multiplexing process performed by the multiplexing module 38. A multiplexing start time is calculated in blocks A1 to A4 in the flowchart of FIG. 5. The multiplexing start time calculator 382 first calculates a data transmission delay (block A1 in FIG. 5). The data transmission delay, which is a delay occurring until the output of a TS-packetized AU is completed, is found by using expression (3):

(TS packet size×the number of TS packets)/TS rate Expression (3)

The number of TS packets in expression (3) is the number of TS packets generated when an AU is formed into a TS packet. The TS rate is the output rate when an ES is turned into a TS. When one audio frame picture is stored in one PES packet, the TS rate is given by expression (4), as follows:

TS rate=ceil (coding rate+PES overhead+TS overhead) Expression (4)
ceil: rounding up to an integer

The PES overhead in expression (4) is given by expression (5), as follows:

PES overhead=PES header length×maximum frame rate expression (5)

The TS overhead is given by adding overhead of the TS header to stuffing byte, or the TS overhead is given by expression (6), as follows:

$$TS overhead = ceil ( average PES size / TS payload length ) \times TS header length \times maximum frame rate + TS payload length \times maximum frame rate \qquad expression ( 6 )$$

The average PES size in expression (6) is given by expression (7), as follows:

Average PES size=coding rate/maximum frame rate+PES header size expression (7)

Next, the multiplexing start time calculator 382 calculates a multiplexing start time of video ES (block A2 in FIG. 5). In the case of video, the multiplexing start time is the time obtained by subtracting the data transmission delay of AU, initial delay, and decoder delay from the decode time. The initial delay is a coding parameter specified by the encoder. If streams are buffered into the decoder at the coding rate according to the initial delay, they can be reproduced without underflow.

In parallel with this, the multiplexing start time calculator 382 calculates a multiplexing start time of audio ES (block A3 in FIG. 5). In the case of audio, the multiplexing start time is obtained by subtracting the data transmission delay of AU and decoder delay from the decode time. The minimum one of the multiplexing start times is the time at which multiplexing is actually started and the first TS packet is output. The difference between the multiplexing start time and the decode time is a delay occurring until a stream is actually reproduced.

Then, the multiplexing start time calculator 382 sets a stream whose multiplexing start time takes a minimum value as an output rate adjustment stream and its multiplexing start time as an output rate adjustment start time (block A4 in FIG. 5). Generally, a video ES needs an initial delay of several seconds. Therefore, if the video decode time and audio decode time are the same, the multiplexing of the video ES has to be started several seconds earlier than that of the audio ES. The difference in multiplexing start time between the video ES and audio ES is reduced by a multiplexing start time adjustment process in the next block A5, thereby alleviating a delay occurring from when a TS is input to the decoder until the TS is reproduced. FIG. 6 is an exemplary flowchart showing a detailed flow of the multiplexing start time adjustment process in block A5.

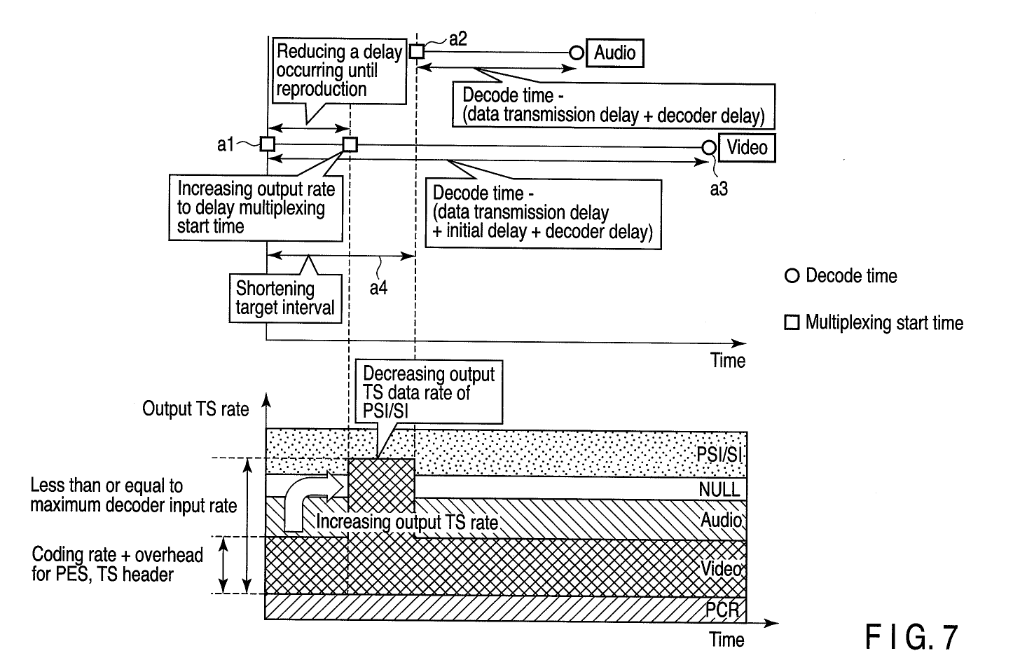

First, a delay shortening interval calculator 383 calculates a delay shortening target interval and the TS data amount sent in the interval (block B1 in FIG. 6). The output rate adjustment start time has been determined in block A4 of FIG. 5. FIG. 7 is an exemplary conceptual diagram to visually describe the adjustment of the multiplexing start time. An output rate adjustment end time is the earlier one of the decode time of the output rate adjustment stream (“a3” in FIG. 7) and a multiplexing start time of ES which has a second multiplexing start time (“a2” in FIG. 7). In FIG. 7, the output rate adjustment end time is “a2”. The output rate adjustment end time can be calculated by multiplying the shortening target interval (“a4” in FIG. 7) by the TS rate given by expression (4) and the shortening interval.

Next, a program information output setting module 384 adjusts the PSI/SI output data amount as needed. More specifically, the program information output setting module 384 checks whether the TS rate of output rate adjustment streams can be increased to the decoder maximum input rate (block B2 in FIG. 6). This can be checked by comparing the TS rate with a value obtained by subtracting the amount of TS data excluding the NULL packets sent in the shortening target interval (“a4” in FIG. 7) from the transport rate.

If data was not able to be output at the decoder maximum input rate (NO in block B2 in FIG. 6), the program information output setting module 384 extends the output period of PSI/SI to the upper limit of the period adjustable range determined in, for example, ARIB TR-B14, that is, by 30% (block B3 in FIG. 6). As a result, the output TS rate of PSI/SI decreases and the band allocated to output rate adjustment streams increases.

Thereafter, the program information output setting module 384 checks again whether the TS rate of output rate adjustment streams can be increased to the decoder maximum input rate (block B4 in FIG. 6). If the TS rate cannot be increased (NO in block B4), the program information output setting module 384 sets a multiplexing start time of PSI/SI having lower-priority after “a2” in FIG. 7 (block B5 in FIG. 6). For prioritization, there is a method of increasing the priority of, for example, PAT and PMT indispensable for decoding. With this method, the output TS rate of the relevant PSI/SI in the shortening target interval can be set at 0 bps. The transmission period and multiplexing start time of the PSI/SI adjusted as described above are recorded in an output control information storage module 387, which is referred to when an output packet selection module 388 selects a packet to be output.

Then, an output rate adjustment module 385 determines the output TS rate of the output rate adjustment streams temporarily increased (block B6 in FIG. 6). When PSI/SI has been adjusted, a decrease in the output TS rate of PSI/SI is added to the output TS rate of the output rate adjustment streams. The independently determined output TS rate and the output rate adjustment end time are recorded in the output control information storage module 387, which is referred to when the output packet selection module 388 selects a packet to be output.

Furthermore, the multiplexing start time adjustment module 386 resets a multiplexing start time. More specifically, first, the multiplexing start time adjustment module 386 calculates a shortened time due to an increase in the output TS rate of output rate adjustment streams according to expression (8), as follows (block B7 in FIG. 6):

Shortened time=shortening interval−(output TS data amount/output TS rate of output rate adjustment streams) expression (8)

Then, the multiplexing start time adjustment module 386 subtracts the shortened time from the multiplexing start time of the earliest ES, thereby resetting a multiplexing start time (block B8 in FIG. 6).

The multiplexing start time reset in the multiplexing start time adjustment process in block A5 of FIG. 5 is input to the reference clock 40 and used as an initial time for the reference clock 40 (block A6 in FIG. 5).

The process at the start of multiplexing is carried out as described above in the information processing apparatus 1.

In addition to this, the information processing apparatus 1 also carries out the process of deleting the HRD parameter in the ES at the video packetizing module 35 when video complies with H.264.

The Rxvid is specified in the HRD parameter in the ES. In ARIB TR-B14, the HRD parameter is inserted arbitrarily and may be omitted. When the HRD parameter is omitted, RXvid is determined on the basis of Level, one of the coding parameters in H.264. On the basis of this rule, the HRD parameter is removed, thereby improving the maximum decoder input rate.

With the information processing apparatus 1, buffering can be performed at a higher rate when an image medium requires a specific amount of buffering until reproduction is performed, which alleviates a delay in reproduction unfavorable for the user. Since this measure can be realized only by a multiplexing process, there is no need to modify the encoder-decoder. Accordingly, this technique has a wide variety of applications.

Furthermore, setting the output TS rate improvement interval and its upper limit as described above makes it unnecessary to manage the buffering amount while the output rate is being increased, which produces the merit of simplifying the process. Moreover, after the output rate has risen, multiplexing has only to be performed at a coding rate specified by each encoder, which produces the merit of carrying out no special process.

Therefore, according to the information processing apparatus 1, a delay in starting the reproduction of multiplexed stream data is reduced.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a multiplexer configured to receive coding stream data comprising first coding stream data and second coding stream data and attribute information corresponding to the coding stream data, to multiplex the coding stream data into multiplexed stream data, and to transmit the multiplexed stream data at a predetermined output rate, the attribute information comprising a first coding parameter and first decode time information which correspond to the first coding stream data and a second coding parameter and second decode time information which correspond to the second coding stream data,
the multiplexer comprising:
a multiplexing start time calculator configured to calculate a first multiplexing start time using the first coding parameter, the first decode time information and a decoder delay time of a decoder configured to decode the multiplexed stream data, and to calculate a second multiplexing start time using the second coding parameter, the second decode time information and the decoder delay time, the decoder delay time being time from when the decoder receives the multiplexed stream data until when the decoder starts decoding of the multiplexed stream data; and
an output rate adjustment module configured to set:
coding stream data where the earlier one of the first multiplexing start time and the second multiplexing time has been calculated as output rate adjustment stream data; and
decode time of the coding stream data where the earlier one of the first multiplexing start time and the second multiplexing time has been calculated as an output rate adjustment start time,
to set time where the earlier one of (i) the later one of the first multiplexing start time and the second multiplexing start time and (ii) decode time of a coding data at the head of the output rate adjustment stream data as a output rate adjustment end time,
to calculate the output data amount of the output rate adjustment stream data in the difference interval between the output rate adjustment start time and the output rate adjustment end time using coding parameter of the output rate adjustment stream data, and
to increase the output rate of the output rate adjustment stream data while sustaining the output rate of the multiplexed stream data and sustaining a data size in a buffer of the decoder smaller or equal to the size of the buffer.

2. The apparatus of claim 1, wherein the multiplexer is configured to output the multiplexed stream data in Moving Picture Experts Group (MPEG)-2 transport stream (TS) form.

3. The apparatus of claim 2, wherein the multiplexer is configured to use delay time from one TS packet is input to a Transport System Target Decoder (T-STD) until the decoding of the TS packet is started as the decoder delay time, and to use the substantially maximum input rate of the decoder as a minimum value of the transfer rate of TS data when the output rate from a transport buffer of the T-STD is converted into the transfer rate of TS data.

4. The apparatus of claim 2, wherein the output rate adjustment module is configured to adjust the output period of Program Specific Information or Service Information (PSI or SI) when the increasing the output rate of the output rate adjustment stream data causes the output rate of the multiplexed stream data to exceed the predetermined output rate.

5. The apparatus of claim 4, wherein the output rate adjustment module is configured to adjust the multiplexing start time of lower-priority PSI or SI when the output rate exceeds the predetermined output rate despite the adjustment of the output period of the PSI or SI.

6. The apparatus of claim 5, wherein the multiplexer is configured to set the priority of a program association table (PAT) and a program map table (PMT) high in PSI or SI.

7. The apparatus of claim 2, wherein:
the coding stream data comprises coding stream data of encoded moving images compliant with the H.264 standard, and
the multiplexer is configured to delete a hypothetical reference decoder (HRD) parameter from the coding stream data of the moving images before multiplexing.

8. An information processing apparatus comprising:
a multiplexer configured to input coding stream data items comprising coding stream data items obtained by encoding moving images by an encoding method complying with the H.264 standard, to delete a hypothetical reference decoder (HRD) parameter from the coding stream data, to multiplex the coding stream data after deleting the HRD parameter, and to output the multiplexed stream data.

9. A multiplexing method of an information processing apparatus configured to receive coding stream data comprising first coding stream data, second coding stream data and attribute information corresponding to the coding stream data, to multiplex the coding stream data, and to transmit the multiplexed stream data at a predetermined output rate, the attribute information comprising a first coding parameter and a first decode time information which correspond to the first coding stream data and a second coding parameter and a second decode time information which correspond to the second coding stream data, the multiplexing method comprising:
calculating a first multiplexing start time using the first coding parameter, the first decode time information and a decoder delay time in a decoder configured to decode the multiplexed stream data, the decoder delay time being time from when the decoder receives the multiplexed stream data until the decoder starts decoding of the multiplexed stream data; and
calculating a second multiplexing start time using the second coding parameter, the second decode time information and the decoder delay time;
setting coding stream data where the earlier one of the first multiplexing start time and the second multiplexing time has been calculated as output rate adjustment stream data, and decode time of the earlier one of the first multiplexing start time and the second multiplexing time has been calculated as an output rate adjustment start time,
setting time where the earlier one of (i) the later one of the first multiplexing start time and the second multiplexing start time and (ii) decode time of a coding data at the head of the output rate adjustment stream data as a output rate adjustment end time;
calculating the output data amount of the output rate adjustment stream data in the difference interval between the output rate adjustment start time and the output rate adjustment end time coding parameter of the output rate adjustment stream data; and
increasing the output rate of the output rate adjustment stream data while sustaining the output rate of the multiplexed stream data and sustaining a data size in a buffer of the decoder smaller or equal to the size of the buffer.

10. The method of claim 9, wherein the apparatus outputs the multiplexed stream data in MPEG-2 TS form, and
the method further comprising adjusting the output period of PSI or SI when the increasing the output rate of the output rate adjustment stream data causes the output rate of the multiplexed stream data to exceed the predetermined output rate.

11. The method of claim 10, further comprising adjusting the multiplexing start time of lower-priority PSI or SI when the output rate exceeds the predetermined output rate despite the adjustment of the output period of the PSI or SI.
